(19) United States
(12) Patent Application Publication
(10) Pub. No.: US 2019/0024907 A1
(43) Pub. Date: Jan. 24, 2019

(54) BOILER SERVICE AND MAINTENANCE VALVE

(71) Applicants: Charanjit Singh BATH, Hayes, Middlesex (GB); Mustafa BECHAREF, Hayes, Middlesex (GB)

(72) Inventors: Charanjit Singh BATH, Hayes, Middlesex (GB); Mustafa BECHAREF, Hayes, Middlesex (GB)

(21) Appl. No.: 16/069,311

(22) PCT Filed: Jan. 13, 2017
(86) PCT No.: PCT/GB2017/050089

§ 371 Date: Jul. 11, 2018

(30) Foreign Application Priority Data
Jan. 15, 2016 (GB) 1600817.9

(51) Int. Cl. F24D 19/10; F16K 11/087; F24D 3/10; F24D 19/00

(52) U.S. Cl. CPC F24D 19/1027; F24D 19/0092; F24D 3/1083; F16K 11/0873

(57) ABSTRACT

A boiler service and maintenance valve (20) comprises a body (21) having a first connector (28), a second connector (29), and a separate flush entrance (31). Each of the first connector (28) and the second connector (29) is adapted for connection to a conduit of a water heating system (60). The body (21) further comprises a valve member (47) arranged for movement between at least a first open position for opening the flush entrance (31) and a closed position for closing the flush entrance (31). The first open position allows fluid communication between the flush entrance (31) and at least one of the first connector (28) and the second connector (29). The closed position allows fluid communication between the first connector (29) and the second connector (29), but not the flush entrance (31).

This invention relates, in a first aspect thereof, to a boiler service and maintenance (BSM) valve for use in flushing and descaling a system, in particular a water heating system. In a second aspect thereof, the invention relates to a modified water heating system incorporating such boiler service and maintenance valves. In a third aspect thereof, the invention relates to a method of servicing a modified water heating system incorporating such boiler service and maintenance valves.

The term “water heating system” as used herein is intended to encompass substantially all kinds of domestic and commercial water heating systems and water-based central heating systems.

Increasing improvements in technology and servicing procedures, together with a growing awareness of environmental and cost concerns have led to a desire amongst consumers to maintain water heating system apparatus, such as boilers, rather than replacing them at regular intervals. Conventional domestic and commercial water heating systems however only provide limited access for maintenance. Gaining access to the system requires a large amount of time for the engineer and thus high costs.

At present, the domestic boiler industry in particular wastes a great deal of money due to incorrect service procedures. Boilers need regular services, to prevent the boiler and associated water heating system from scaling or silting up due to impurities in the liquid used, usually water. However, there is currently no generally accepted means of servicing boilers without removing parts of the boiler and/or power flushing, which can be costly.

Due to the configuration of conventional water heating systems, it is also generally not possible to flush the boiler separately from the domestic heating system (i.e. the pipes and radiators) and vice versa.

Previous attempts to address the above issues, include the following:

U.S. Pat. No. 7,621,295 (Reck) discloses a fluid isolation valve having a valve body with a first fluid flow port, a second fluid flow port and a fluid drain port with a valve in the fluid drain port. The valve body also defines a fluid flow channel, a drain flow channel and a valve portion, wherein the valve portion is disposed in the valve body to be communicated with the first fluid flow port, the second fluid flow port and the fluid drain port. A flow diversion device is also provided and is disposed within the valve portion. The flow diversion device is configurable between a first configuration and a second configuration, such that when the flow diversion device is in the first configuration the first fluid flow port is communicated with the second fluid flow port. Consequently, when the flow diversion device is in the second configuration the first fluid flow port is communicated with the fluid drain port. The fluid flow can be decreased or stopped by use of the valve within the fluid drain port.

U.S. Pat. No. 7,681,596 (Reck) discloses a fluid isolation valve comprising: a valve body, said valve body having a first fluid flow port, a second fluid flow port and a fluid drain port, wherein said valve body defines a fluid flow channel, a drain flow channel and a valve portion, said valve portion being disposed to be communicated with said first fluid flow port, said second fluid flow port and said fluid drain port; and a flow diversion device disposed within said valve portion, said flow diversion device being configurable between a first configuration and a second configuration, such that when said flow diversion device is in said first configuration said first fluid flow port is communicated with said second fluid flow port and when said flow diversion device is in said second configuration said first fluid flow port is communicated with said fluid drain port.

U.S. Pat. No. 7,849,877 (Tan) discloses a diverter valve which may include a body portion and a lid portion. The lid and body portions may define a fluid chamber. The lid portion may include a first stop and a second stop. A closure member may at least partially be received within the fluid chamber. A movable member, such as a handle, may be operatively associated with closure member. The movable member may be selectively movable relative to the lid portion between the first and second stops. A stop member may be selectively positioned on the lid portion. When positioned between the first and second stops, the stop member may limit movement of the movable member to between the stop member and one of the first and second stops. The first stop, the second stop, or both, may also comprise a stop member.

The present invention seeks to address the above described issues, and further to develop the teachings of the above discussed prior art by providing an improved boiler service and maintenance (BSM) valve and method of use thereof.

According to a first aspect of the present invention there is provided a boiler service and maintenance valve comprising a body having a first connector and a second connector, each adapted for connection to a conduit of a water heating system, and a separate flush entrance, the body further comprising a valve member arranged for movement between at least a first open position for opening the flush entrance and a closed position for closing the flush entrance, wherein the first open position allows fluid communication between the flush entrance and at least one of the first and second connectors, and said closed position allows fluid communication between the first connector and the second connector.

In preferred embodiments of boiler service and maintenance valve according to the first aspect of the present invention, the first open position allows fluid communication between the flush entrance and the first connector only. The valve member is preferably further arranged for movement to a second open position, allowing fluid communication between the flush entrance and the second connector only. In certain embodiments, the valve member may preferably be further arranged for movement to a third open position, allowing fluid communication between all three of the flush entrance, the first connector, and the second connector.

Movement of the valve member from one position to another may be effected by an actuator. Said actuator may comprise a manually-operable actuator, such as a lever. Alternatively, the actuator may comprise an electrically-operable actuator. In some embodiments, the electrically-operable actuator may be activated by a local or remote actuation. The remote actuation may be initiated by a remote device, for example using wireless connectivity or inter-machine operability such as Bluetooth® connectivity.

The valve member may preferably comprise an internal ball valve. The ball valve is preferably enclosed internally within the body and comprises a plurality of apertures arranged in a configuration such that, upon selective rotation of the ball valve, said apertures are oriented so as to enable at least the first open position and the closed position. In the preferred embodiments described above, selective rotation of the ball valve orients said plurality of apertures so as also to enable the second open position, and preferably also the third open position. The actuator is operated from one position to another so as in turn to rotate the ball valve from position to position as described above.

The body may comprise a plurality of faces and is preferably cuboid, having six faces. The first and second connectors are preferably provided on first and second opposed faces. A third face, generally orthogonal to said first and second faces, preferably houses the flush entrance. The actuator may be provided either on a fourth face opposed to said third face, or alternatively on a fifth or sixth faces arranged generally orthogonally to said third face. In some embodiments, one of the fourth, fifth and sixth faces, which does not house the actuator, may house an access port for a filling loop. At least one of the fourth, fifth and sixth faces, which does not house the actuator or the filling loop access port, may be formed as a blank face.

The first and second connectors are each adapted for connection to a conduit of a water heating system. The conduit will preferably be a pipework member of said water heating system, such as a flow or return pipe connected to a boiler. To enable said connection, the connectors preferably comprise external screw-thread connector shafts, olives, and internal screw-thread nuts.

The boiler service and maintenance valve is preferably formed primarily of metal, such as copper, or an alloy thereof. The actuator and/or filling loop access port preferably each comprise a resiliently deformable washer, so as to limit egress of pressurised fluid in relation to moveable parts. Similarly, the flush entrance, and/or the first and second connectors, preferably each comprise a resiliently deformable gasket, so as to limit fluid egress when connected or sealed.

The flush entrance may be sealed by a cap, when access to the heating system via the flush entrance is not required. As will be appreciated from the foregoing, when the valve member is in the first or second open positions, fluid communication between the first connector and the second connector is prevented. Sealing the flush entrance when the valve member is in the first or second open positions thus effectively isolates the part of the water heating system connected to the first connector from the part of the water heating system connected to the second connector. This can be utilised, for example, to enable a boiler to be removed or replaced without draining the entire water heating system.

The boiler service and maintenance valve according to the first aspect of the present invention may be permanently installed in a conduit of a water heating system to provide easy access to the main pipework thereof. More preferably, a pair of boiler service and maintenance valves according to the first aspect of the present invention may be permanently installed in different conduits of said water heating system. Most preferably, one member of said pair of boiler service and maintenance valves may be permanently installed in a flow pipe of a water heating system, and the other member of said pair may be permanently installed in a return pipe of said heating system.

Therefore, according to a second aspect of the present invention there is provided a modified water heating system having a boiler service and maintenance valve according to the first aspect of the present invention permanently installed in a conduit thereof.

Preferably, said modified water heating system has a pair of boiler service and maintenance valves according to the first aspect of the present invention permanently installed in different conduits thereof.

More preferably, one member of said pair of boiler service and maintenance valves is permanently installed in a flow pipe of said water heating system, and the other member of said pair is permanently installed in a return pipe of said heating system. Most preferably, said pair of boiler service and maintenance valves are permanently installed in said flow and return pipes adjacent the boiler.

By having a pair of BSM valves permanently installed, one in the flow pipe and one in the return pipe, the modified water heating system according to the second aspect of the present invention presents a number of service and maintenance options. In particular, this arrangement allows easy access to the modified water heating system so as to service either the whole heating system, just the boiler, or just the pipes and radiators but not the boiler. In order to service just the boiler, a bridging hose is preferably provided, to connect the flush entrances of the valves to one another.

Therefore, according to a third aspect of the present invention there is provided a method of servicing a modified water heating system according to the second aspect of the present invention, wherein said pair of boiler service and maintenance valves are utilised to provide access to the system.

By changing the position of the valve members, said pair of boiler service and maintenance valves can be utilised selectively to provide access to the boiler only, the system excluding the boiler, or the entire system, depending on the user's requirements.

In one embodiment of the method according to the third aspect of the present invention, a power flushing apparatus is connected to the flush entrances of said pair of boiler service and maintenance valves.

In another embodiment of the method according to the third aspect of the present invention, a bridging hose is used to connect the flush entrance of one member of said pair of boiler service and maintenance valves to the flush entrance of the other member of said pair.

In order that the present invention may be more clearly understood, preferred embodiments thereof will now be described in detail, though only by way of example, with reference to the accompanying drawings, in which:

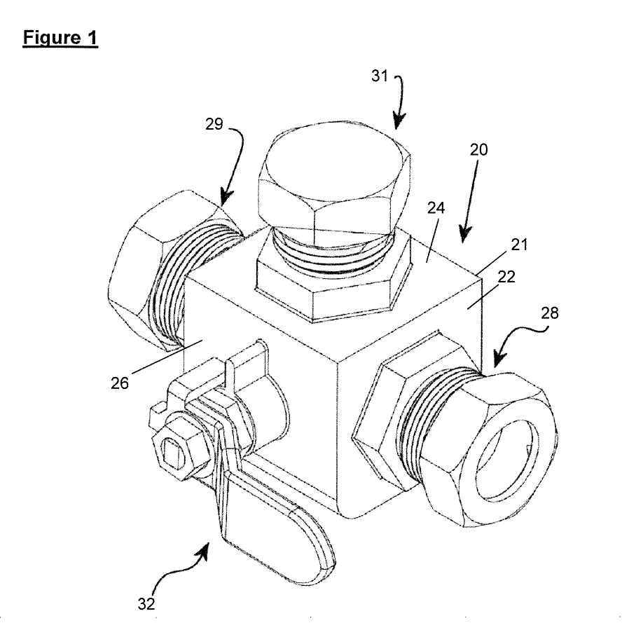

FIG. 1 shows an isometric view of a preferred embodiment of boiler service and maintenance valve according to a first aspect of the present invention;

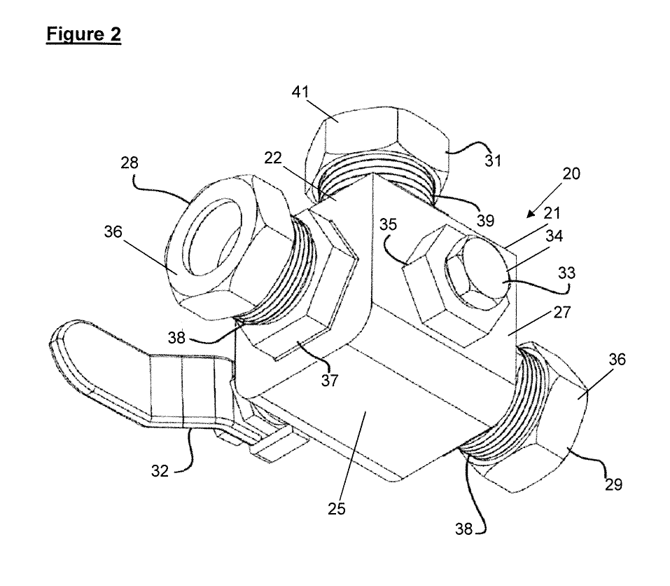

FIG. 2 shows a reverse isometric view of the boiler service and maintenance valve of FIG. 1;

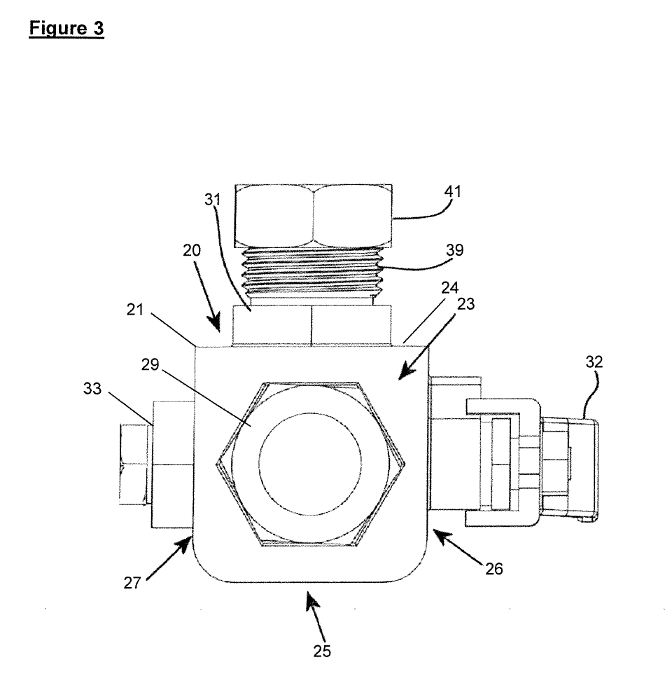

FIG. 3 shows a first side view of the boiler service and maintenance valve of FIGS. 1 and 2;

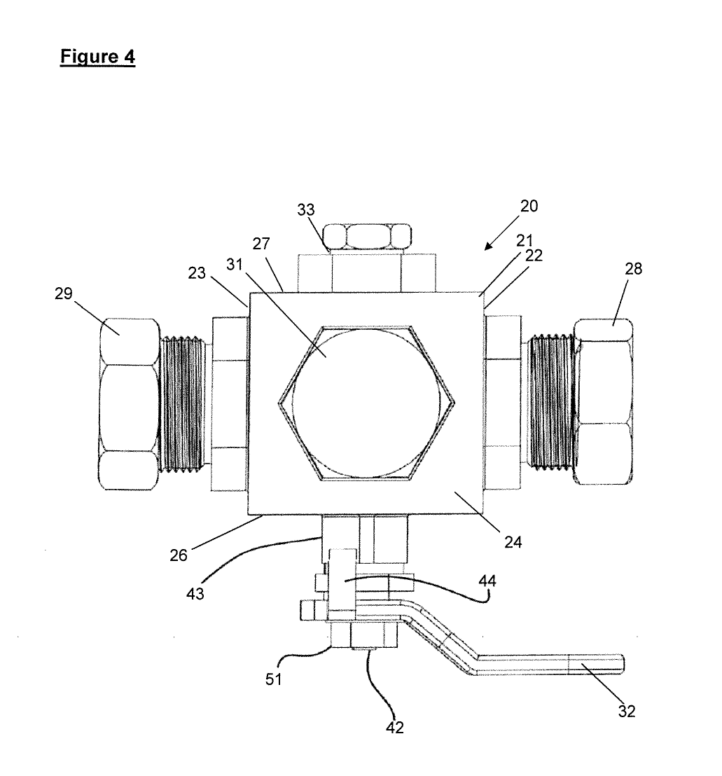

FIG. 4 shows a second side view of the boiler service and maintenance valve of FIGS. 1 to 3;

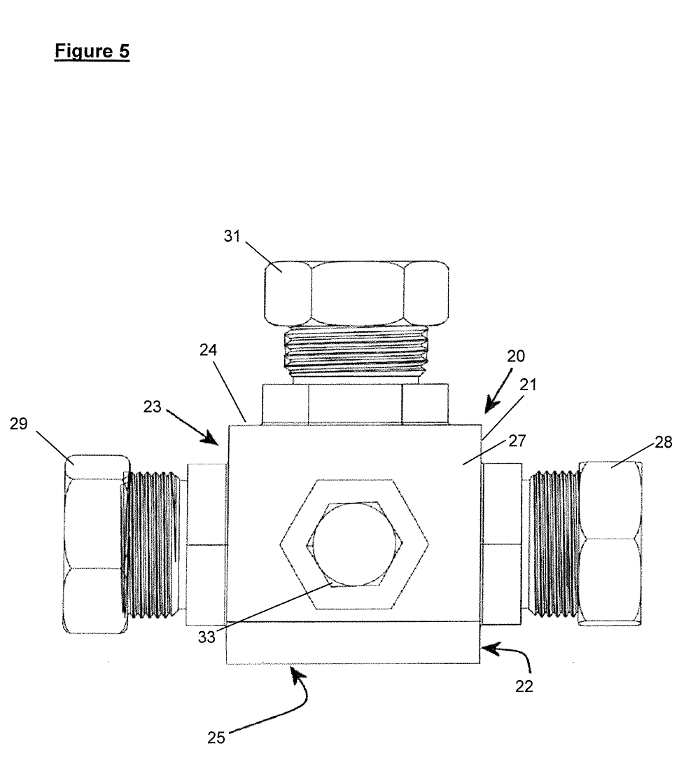

FIG. 5 shows a third side view of the boiler service and maintenance valve of FIGS. 1 to 4;

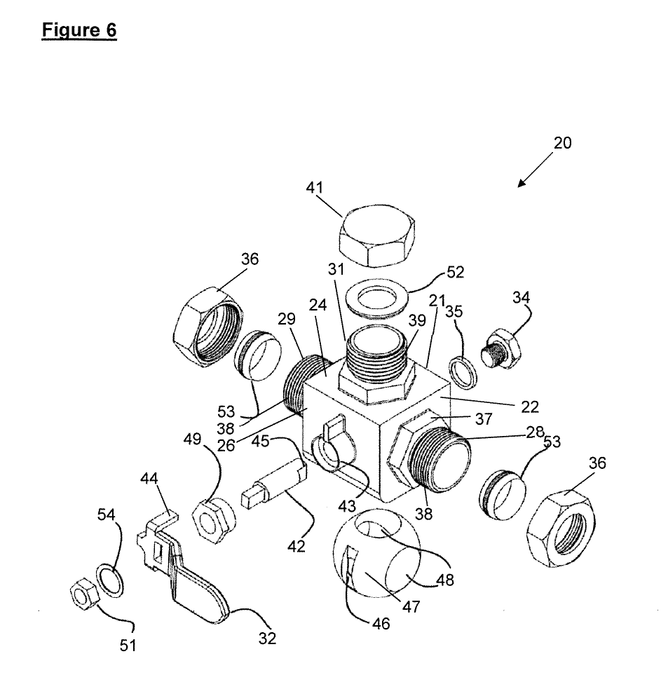

FIG. 6 shows an isometric exploded view of the boiler service and maintenance valve of FIGS. 1 to 5;

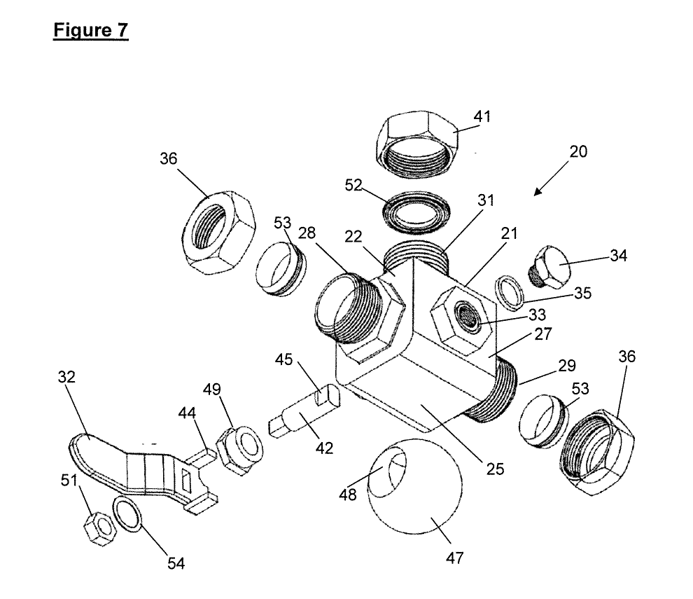

FIG. 7 shows a reverse isometric exploded view of the boiler service and maintenance valve of FIGS. 1 to 6;

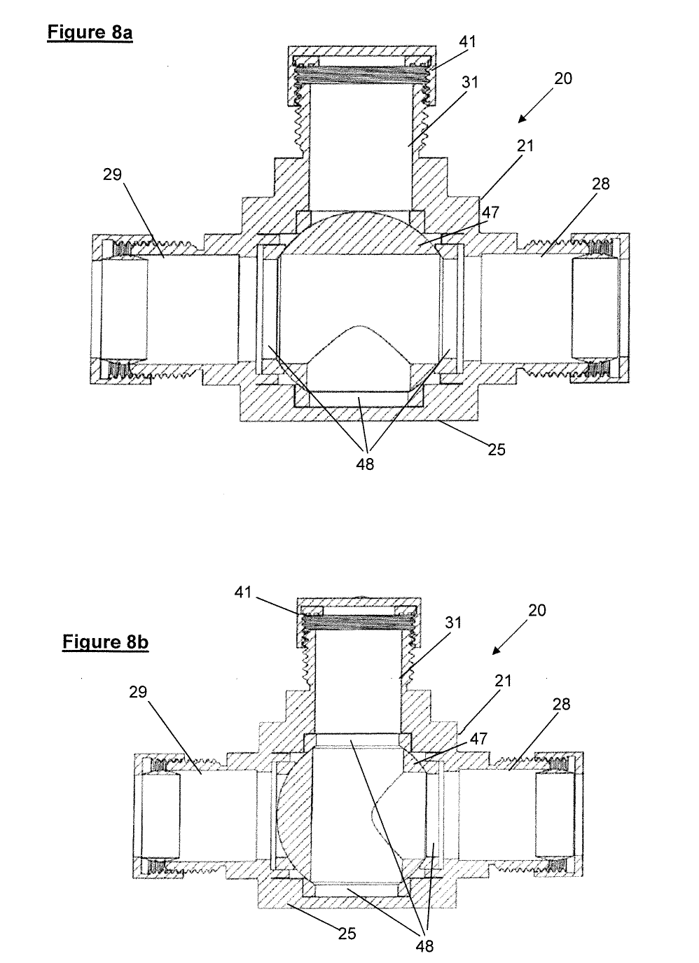

FIG. 8a shows a cross-sectional view of the boiler service and maintenance valve of FIGS. 1 to 7, with the valve member in the closed position;

FIG. 8b shows a cross-sectional view of the boiler service and maintenance valve of FIGS. 1 to 7, with the valve member in the first open position;

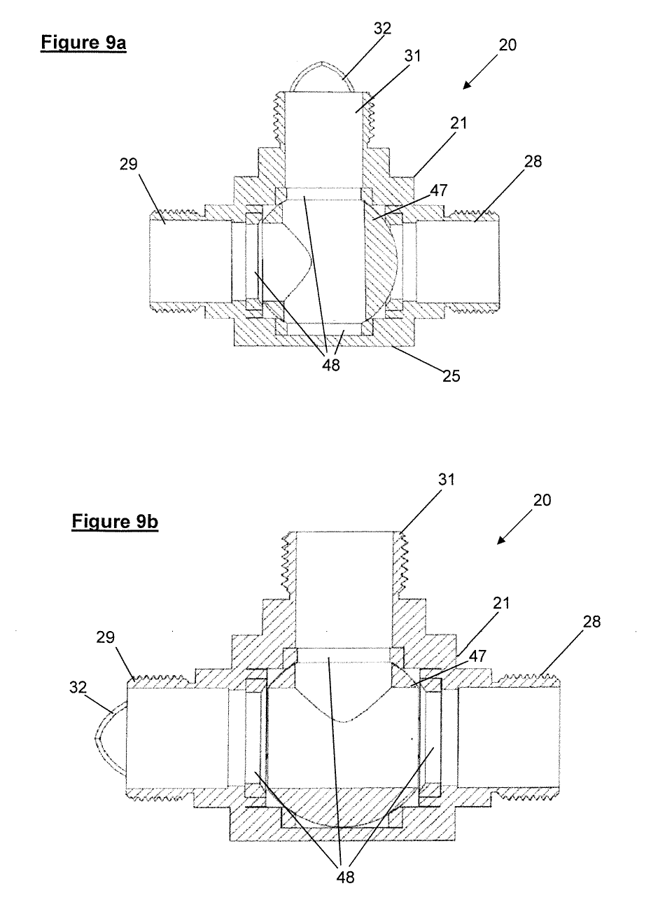

FIG. 9a shows a cross-sectional view of the boiler service and maintenance valve of FIGS. 1 to 8, with the valve member in the second open position;

FIG. 9b shows a cross-sectional view of the boiler service and maintenance valve of FIGS. 1 to 8, with the valve member in the third open position;

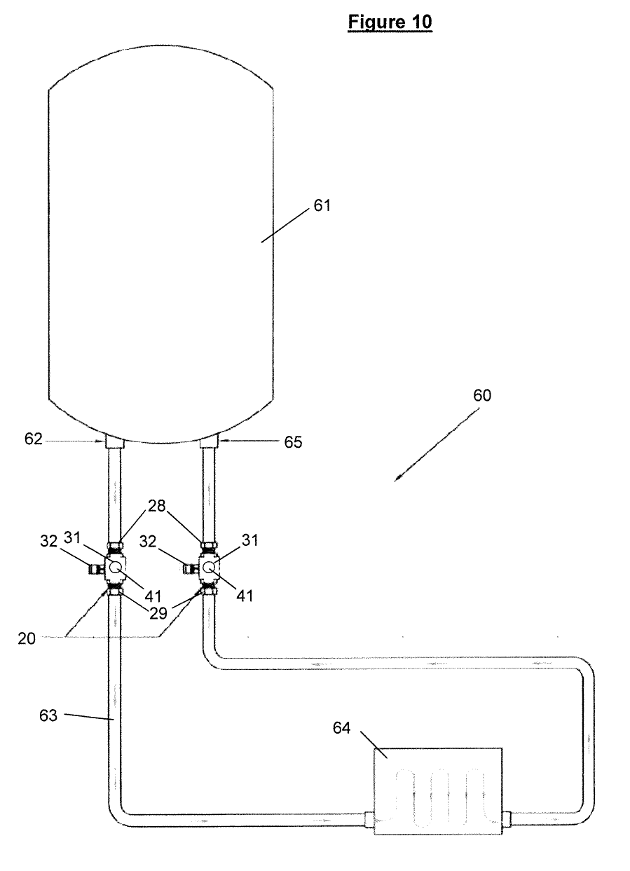

FIG. 10 shows a modified water heating system according to a second aspect of the present invention, featuring a pair of the boiler service and maintenance valves of FIGS. 1 to 9;

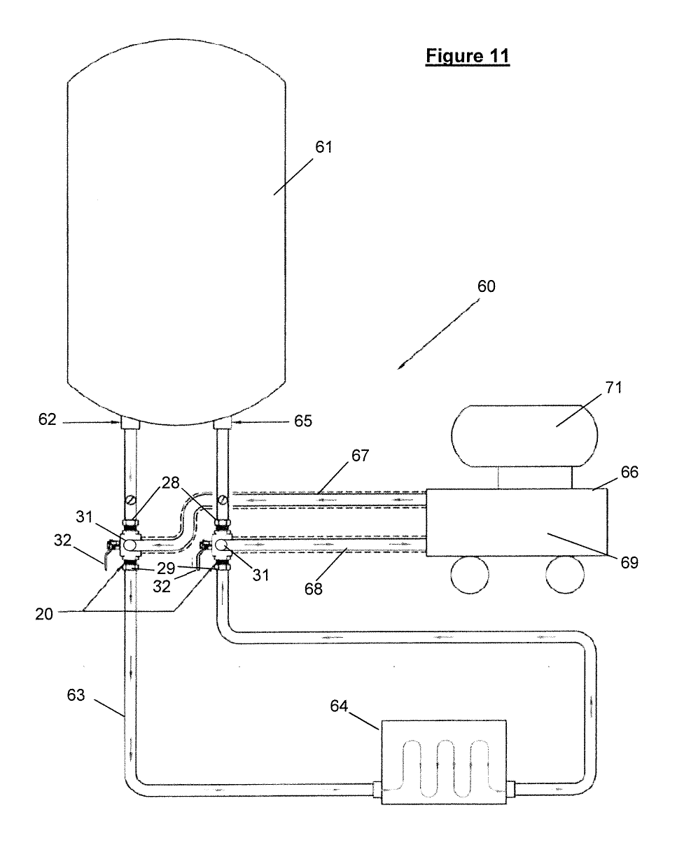

FIG. 11 shows the modified water heating system of FIG. 10 having power flushing apparatus connected thereto for performance of one embodiment of a method of servicing according to a third aspect of the present invention;

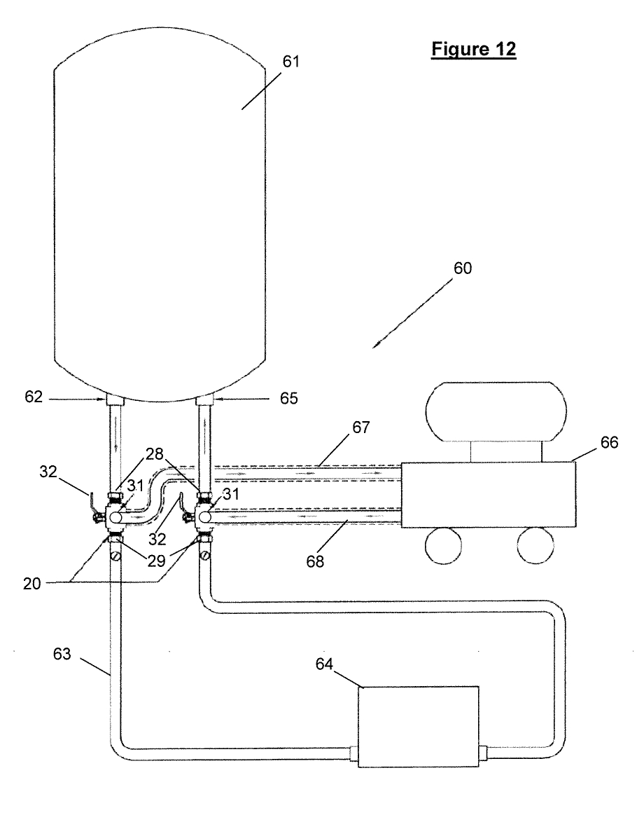

FIG. 12 shows an alternative arrangement of the modified water heating system and power flushing apparatus of FIG. 11;

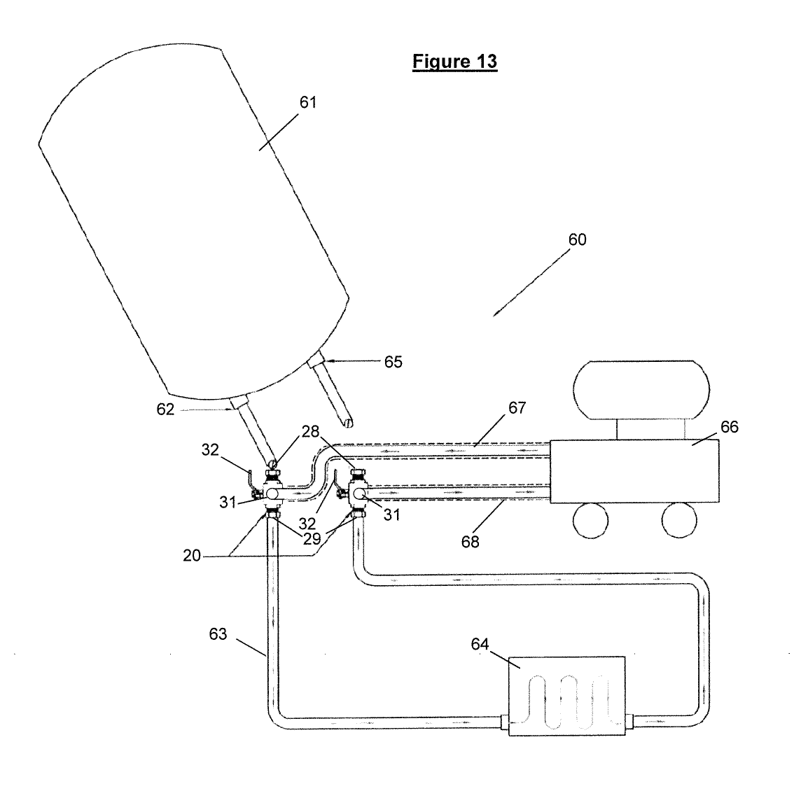

FIG. 13 shows the modified water heating system and power flushing apparatus of FIGS. 11 and 12, with the boiler being removed;

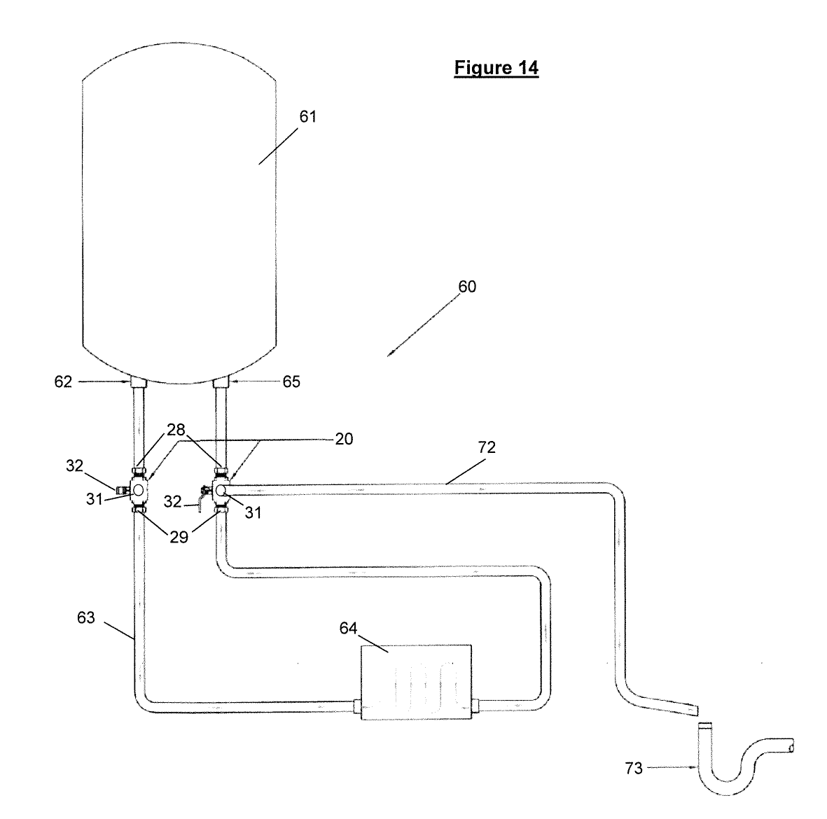

FIG. 14 shows the modified water heating system of FIG. 10 having a draining hose connected thereto for draining the system;

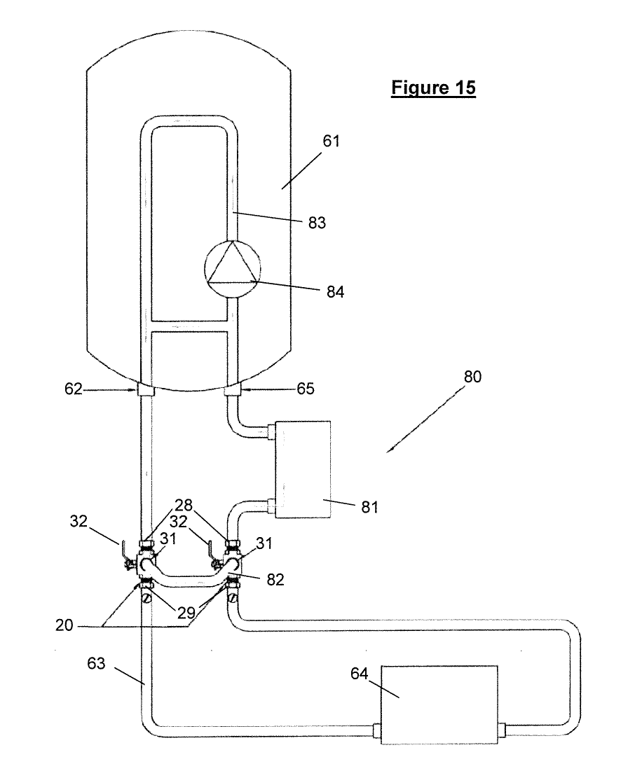

FIG. 15 shows the modified water heating system of FIG. 10 having a bridging hose connected thereto, for performance of an alternative embodiment of a method of servicing according to a third aspect of the present invention; and

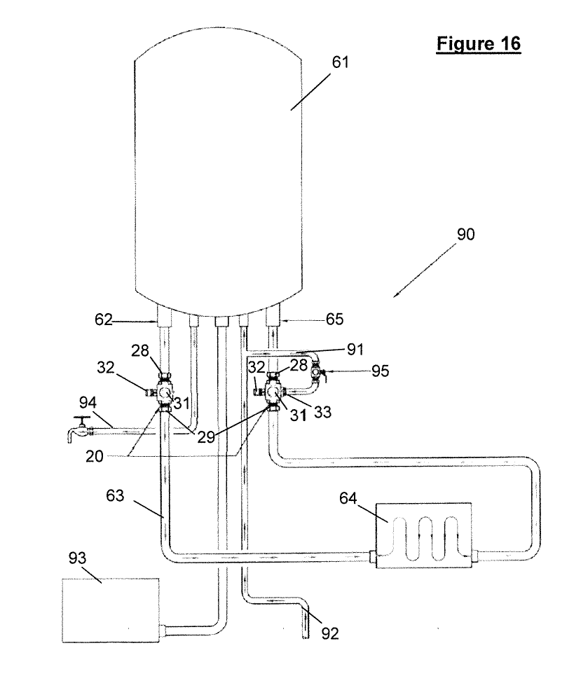

FIG. 16 shows the modified water heating system of FIG. 10 having a filling loop connected to one of the boiler service and maintenance valves.

Referring first to FIGS. 1 to 5, there is shown a preferred embodiment of a boiler service and maintenance (BSM) valve, generally indicated 20, according to a first aspect of the present invention. The BSM valve 20 comprises a central cuboid body 21 having first, second, third, fourth, fifth and sixth substantially equal faces 22, 23, 24, 25, 26, 27, respectively.

The first face 22 is provided with a first connector 28, and the second, opposed face 23 is provided with a second connector 29. The first and second connectors 28, 29 are each adapted for connection to a conduit of a water heating system.

The third face 24, which is generally orthogonal to said first and second faces 22, 23, is provided with a flush entrance 31. The fourth face 25 is opposed to said third face 24, and is formed as a blank face. The fourth face 25 has rounded corners with the fifth and sixth faces 26, 27, so as to allow for integration with other structures in a heating system.

The fifth face 26, which is generally orthogonal to each of the first, second, third and fourth faces, 22, 23, 24, 25 is provided with a manually-operable actuator for the valve 20, in the form of a rotatable lever 32.

The sixth face 27, which is opposed to the fifth face 26, comprises an access port 33 for a 10 mm to 12 mm filling loop. The access port 33 uses standard parts and is shown with a bung 34, screwed into a collar 35.

The connectors 28, 29 are provided with annular nuts 36, collars 37 and screw-threads 38. The body 21 is predominantly formed in brass, and sized with 22 mm or ¾ inch (19mm) screw-threads 38. Alternative embodiments may be envisaged for different connections, different systems and different applications, wherein the valve body 21 may be made any size, for example with connectors of 15 mm, 22 mm, 28 mm and up to 56 mm nuts and olives. Still further alternative embodiments may also be made in plastics with speed-fit connections. The flush entrance 31 comprises a standard ¾ inch (19 mm) screw-thread 39 and a closed capping nut 41 to seal it when not in use.

As can best be seen in FIGS. 6 and 7, the lever actuator 32 comprises a central bore 42, passing through a catch collar 43 to the body 21. This collar 43 allows for wings 44 on the lever 32 to prevent further rotation of the bore 42, so as to provide incremental, staged or limited rotation. The bore 42 passes through a collar nut 49 and is held in place by a closure nut 51. The bore 42 comprises an indented slot end 45 which interfaces with a slot 46 in a ball valve member 47, located internally of the body 21. The ball valve member 47 includes a plurality of apertures 48 arranged in a configuration such that, upon selective rotation of the ball valve member 47, the apertures 48 are oriented so as to enable the valve 20 to adopt its various open and closed positions, as will be described in more detail below with reference to FIGS. 8 and 9.

As can also be seen from FIGS. 6 and 7, the BSM valve 20 further comprises the following additional components: rubber seal 52, olives 53, and washer 54.

Referring now to FIGS. 8 and 9, these show the various orientations of the ball valve member 47 within the valve body 21, which enable the BSM valve 20 to adopt its various open and closed positions.

FIG. 8a shows the valve 20 in its closed position. The term “closed” is used herein to signify that the flush entrance 31 is closed. It should thus be understood that when the valve 20 is in the closed position, water from the heating system conduit will continue to flow normally between the first and second connectors 28, 29, through the valve body 21. As can be seen in FIG. 8a, the ball valve member 47 presents three apertures 48, arranged in a substantially T-shaped configuration. When in the closed position as shown in FIG. 8a, one said aperture 48 is in communication with the first connector 28, another said aperture 48 is in communication with the second connector 29, and the remaining aperture 48 is oriented towards the fourth face 25 of the valve body 21, but does not communicate with any connector or conduit. As can be seen, in this closed position the flush entrance 31 is not in fluid communication with the ball valve member 47 and therefore is also not in fluid communication with the first or second connectors 28, 29.

FIG. 8b shows the valve 20 in its first open position, which enables fluid communication between the first connector 28 and the flush entrance 31. The ball valve member 47 has now been rotated 90° counter-clockwise from the closed position shown in FIG. 8a. In this first open position, one aperture 48 of the ball valve member 47 is in communication with the first connector 28, another aperture 48 is in communication with the flush entrance 31, and the remaining aperture 48 is oriented towards the fourth face 25 of the valve body 21, but does not communicate with any connector or conduit. As can be seen, in this first open position the second connector 29 is not in fluid communication with the ball valve member 47 and therefore is also not in fluid communication with the first connector 28 or the flush entrance 31. Note that FIG. 8b shows the flush entrance 31 with the cap 41 in place. This would then need to be removed to provide service access to the heating system via the conduit connected to the first connector 28.

FIG. 9a shows the valve 20 in its second open position, which enables fluid communication between the second connector 29 and the flush entrance 31. The ball valve member 47 has now been rotated 90° clockwise from the closed position shown in FIGS. 8a, and 180° from the first open position shown in FIG. 8b. In this second open position, one aperture 48 of the ball valve member is in communication with the second connector 29, another aperture 48 is in communication with the flush entrance 31, and the remaining aperture 48 is oriented towards the fourth face 25 of the valve body 21, but does not communicate with any connector or conduit. As can be seen, in this second open position the first connector 28 is not in fluid communication with the ball valve member 47 and therefore is also not in fluid communication with the second connector 29 or the flush entrance 31. FIG. 9a shows the flush entrance 31 with the cap 41 removed, thus providing service access to the heating system via the conduit connected to the second connector 29.

FIG. 9b shows the valve 20 in its third open position, which enables fluid communication between all three of the first connector 28, the second connector 29 and the flush entrance 31. The ball valve member 47 has now been rotated a further 90° clockwise from the second open position shown in FIG. 9a. In this third open position, one aperture 48 of the ball valve member is in communication with the first connector 28, another aperture 48 is in communication with second connector 29, and the remaining aperture 48 is in communication with the flush entrance 31. In this third open position, service access is provided to the heating system via the conduit connected to both the first connector 28 and the second connector 29.

Referring now to FIG. 10, there is shown a preferred embodiment of a modified water heating system, generally indicated 60, according to a second aspect of the present invention, having installed therein a pair of boiler service and maintenance valves 20 as hereinbefore described with reference to FIGS. 1 to 9. The heating system 60 comprises a boiler 61 having a flow (outlet) pipe 62 feeding a domestic heating loop 63, which for simplicity is shown comprising a single radiator 64. An return (inlet) pipe 65 completes the loop 63, returning water to the boiler 61. As can be seen, one valve 20 is installed in the flow pipe 62, and the other valve 20 is installed in the return pipe 65. Both valves 20 are installed directly beneath the boiler 61. As can be seen, for each valve 20, the first connector 28 is connected to the boiler 61, whilst the second connector 29 is connected to the heating loop 63.

For normal operation of the heating system, the caps 41 will be in place on the flush entrances 31 of the valves 20, and the levers 32 will be arranged such that the valves 20 adopt the closed position as shown in FIG. 8a. For each valve 20, fluid communication is thus permitted between the first connector 28 and the second connector 29, but not the flush entrance 31.

Referring now to FIG. 11, this shows the modified water heating system 60 as in FIG. 10, but with power flushing apparatus 66 connected thereto. An outlet hose 67 connects the power flushing apparatus 66 to the flush entrance 31 of the valve 20 installed in the flow pipe 62, whilst an inlet hose 68 connects the flush entrance 31 of the valve 20 installed in the return pipe 65 to the power flushing apparatus 66, to complete the loop. The caps 41 have now been removed from the flush entrances 31 to enable these connections. The levers 32 are now arranged such that valves 20 adopt the third open position as shown in FIG. 9b, so that for each valve 20, all three of the flush entrance 31, the first connector 28 and the second connector 29 are in fluid communication. The power flushing apparatus 66 can thus be used to flush the entire heating system 60 including both the boiler 61 and the heating loop 63.

The power flushing apparatus 66 has a pump 69 and a water tank 71. Water can thus be pumped through the system 60 as indicated by the flow arrows in FIG. 11.

Referring now to FIG. 12, this shows the heating system 60 and power flushing apparatus 66 as in FIG. 11, but with the levers 32 now arranged such that the valves 20 adopt the first open position as shown in FIG. 8b. For each valve 20, fluid communication is now permitted between the flush entrance 31 and the first connector 28, but not the second connector 29. The power flushing apparatus 66 thus now has access to the boiler 61 but not the heating loop 63. This arrangement can be used for descaling of the boiler 61, with the power flushing apparatus 66 operating in reverse mode such that water flows from the power flushing apparatus 66 to the boiler 61 via the inlet hose 68 and is returned to the power flushing apparatus 66 via the outlet hose 67.

Referring now to FIG. 13, this shows the heating system 60 and power flushing apparatus 66 as in FIGS. 11 and 12, but with the levers 32 now arranged such that the valves 20 adopt the second open position as shown in FIG. 9a. For each valve 20, fluid communication is now permitted between the flush entrance 31 and the second connector 29, but not the first connector 28. The power flushing apparatus 66 thus now has access to the heating loop 63, but not the boiler 61. This arrangement can be used for power flushing the heating loop 63 in isolation, but more importantly, as illustrated in FIG. 13 the boiler 61 can be replaced simultaneously whilst the power flushing of the heating loop 63 is carried out. This enables a significant time (and therefore cost) saving; previously, a typical power flushing procedure would take a day to carry out, with a further day required to replace the boiler 61. Utilising the above described method according to the third aspect of the present invention enables both procedures to be carried out in a single day.

Referring now to FIG. 14, this shows the heating system 60 as in FIG. 10, but with a draining hose 72 connected to the flush entrance 31 of the valve 20 on the return pipe 65. The lever 32 of the valve 20 on the flow pipe 62 is arranged such that said valve 20 adopts the closed position as shown in FIG. 8a. Fluid communication is thus permitted between the first connector 28 and the second connector 29, but not the flush entrance 31. However, the lever 32 of the valve 20 on the return pipe 65 is arranged such that said valve 20 adopts the second open position as shown in FIG. 9a. Fluid communication is thus permitted between the second connector 29 and the flush entrance 31, but not the first connector 28. Water flowing to said valve 20 from the heating loop 63 is thus diverted into the draining hose 72, rather than being returned to the boiler 61. This arrangement can thus be used to drain the system 60 safely and efficiently into an external drain 73.

Referring now to FIG. 15, this shows an alternative embodiment of modified heating system, generally indicated 80, according to the second aspect of the present invention. The heating system 80 is similar in most respects to that described above with reference to FIG. 10, and like reference numerals are used to refer to like components. This embodiment of heating system 80 differs however in that a magnetic filter 81 is provided in the return pipe 65, located between the valve 20 installed in said return pipe 65, and the boiler 61. FIG. 15 also shows the heating system 80 with a bridging hose 82 inter-connecting the flush entrances 31 of the two valves 20. The levers 32 of the valves 20 are now arranged such that the valves 20 adopt the first open position as shown in FIG. 8b. For each valve 20, fluid communication is thus permitted between the first connector 28 and the flush entrance 31, but not the second connector 29.

The boiler 61 is thus isolated from the heating loop 63, and this arrangement can therefore now be used in a method, according to the third aspect of the present invention, of descaling the boiler 61 without needing to remove any of its component parts. A flushing chemical is added to the water flowing around the internal conduits 83 of the boiler 61. This descales all of the internal components of the boiler 61. The boiler's own pump 84 is used to circulate the fluid around the conduits 83, and out through the flow pipe 62. Upon reaching the valve 20 in the flow pipe 62, the fluid is diverted through the bridging hose 82 to the valve 20 in the return pipe 65, instead of flowing into the heating loop 63. From the valve 20 in the return pipe 65, the fluid passes through the magnetic filter 81 before being returned to the boiler 61. The magnetic filter 81 collects any ferrous debris and sludge broken down by the flushing chemical. This descaling method saves time and cost compared to conventional methods, by avoiding the need to remove or replace parts and components of the boiler 61.

Referring finally to FIG. 16, this shows a further alternative embodiment of modified heating system, generally indicated 90, according to the second aspect of the present invention. The heating system 90 is again similar in most respects to that described above with reference to FIG. 10, and like reference numerals are used to refer to like components. This embodiment of heating system 90 differs however in that it includes a filling loop 91 connected to the filling loop access port 33 of the valve 20 in the return pipe 65. As the filling loop 91 is connected directly to the access port 33, the valves 20 can remain in their closed position, as shown in FIG. 8a, for normal operation of the heating system 90. As the access port 33 is located in the fourth face 25 of the valve body 21, it will be appreciated by reference to FIG. 8a that fluid communication between the filling loop 91 and the first and second connectors 28, 29 is enabled when the valve 20 is in its closed position. The filling loop 91 is used to pressurise the heating system 90.

An external (usually mains) cold water supply 92 feeds the system 90, and is heated by the boiler 61 using a power (usually gas or electricity) supply 93. The heated water is then circulated around the heating loop 63 and radiator(s) 64 via the flow and return pipes 62, 65. Combination heating systems 90 of this kind will also have a domestic hot water outlet 94 for supplying hot water taps, showers etc. The filling loop 91 is fed directly by the cold water supply 92 to re-pressurise the system when required. The filling loop 91 is provided with a further valve 95, which can be opened to allow water to flow into the heating loop 63 via the BSM valve 20 in the return pipe 65, to re-pressurise the heating loop 63 when required.

The boiler service and maintenance valves 20 of the present invention may additionally be used for other purposes such as connecting water softeners or other components to modified water heating systems 60, 80, 90. The invention has been described above by way of examples only and it will be appreciated that variation may be made to the above-mentioned embodiments without departing from the scope of invention. In particular, it will be understood that any features described in relation to any particular embodiment may also be featured in combinations with other embodiments.

1. A boiler service and maintenance valve comprising a body having a first connector and a second connector, each of said first connector and said second connector being adapted for connection to a conduit of a water heating system, and a separate flush entrance, the body further comprising a valve member comprising an internal ball valve, said valve member being arranged for movement between at least a first open position for opening the flush entrance and a closed position for closing the flush entrance, wherein the first open position allows fluid communication between the flush entrance and at least one of the first connector and the second connector, and said closed position allows fluid communication between the first connector and the second connector.

2. A boiler service and maintenance valve as claimed in claim 1, wherein the first open position allows fluid communication between the flush entrance and the first connector only.

3. A boiler service and maintenance valve as claimed in claim 2, wherein the valve member is further arranged for movement to a second open position, and wherein said second open positon allows fluid communication between the flush entrance and the second connector only.

4. A boiler service and maintenance valve as claimed in claim 2, wherein the valve member is further arranged for movement to a third open position, and wherein said third open position allows fluid communication between all of the flush entrance, the first connector, and the second connector.

5. A boiler service and maintenance valve as claimed in claim 1, further comprising an actuator arranged to effect motion of the valve member between said open and closed positions.

6. A boiler service and maintenance valve as claimed in claim 5, wherein said actuator is or comprises a manually-operated actuator.

7. A boiler service and maintenance valve as claimed in claim 5, wherein the actuator comprises a lever.

8. A boiler service and maintenance valve as claimed in claim 5 wherein said actuator comprises an electrically-operated actuator.

9. (canceled)

10. A boiler service and maintenance valve as claimed in claim 1 wherein the body further comprises an access port for a filling loop.

11. A modified water heating system having a boiler, at least one radiator, and at least two conduits, and a pair of boiler service and maintenance valves, wherein each said boiler service and maintenance valve is as claimed in claims 1, and wherein each said boiler service and maintenance valve is installed in a different conduit.

12. A modified water heating system as claimed in claim 11, wherein said at least two conduits comprise a flow pipe and a return pipe, and wherein a first member of said pair of boiler service and maintenance valves is installed in the flow pipe, and a second member of said pair is installed in the return pipe.

13. A modified water heating system as claimed in claim 12, and wherein said pair of boiler service and maintenance valves are installed in said flow and return pipes adjacent said boiler.

14. A modified water heating system as claimed in claim 11, further comprising a bridging hose adapted to connect the flush entrance of a first member of said pair of boiler service and maintenance valves to the flush entrance of a second member of said pair.

15. A method of servicing a modified water heating system as claimed in claim 11, wherein said pair of boiler service and maintenance valves are utilised to provide access to the system.

16. A method as claimed in claim 15, wherein said pair of boiler service and maintenance valves are utilised to provide access to the boiler only.

17. A method as claimed in claim 15, wherein said pair of boiler service and maintenance valves are utilised to provide access to the modified water heating system, excluding the boiler.

18. (canceled)

19. A method as claimed in claim 15, wherein a power flushing apparatus is connected to the flush entrances of said pair of boiler service and maintenance valves.

20. A method as claimed in claim 15, wherein a bridging hose is used to connect the flush entrance of a first member of said pair of boiler service and maintenance valves to the flush entrance of a second member of said pair.
